(19) United States
(12) Patent Application Publication
(10) Pub. No.: US 2015/0314541 A1
(43) Pub. Date: Nov. 5, 2015

(54) Thermoformed in-Mold Labeling Using Lenticular Label

(71) Applicant: National Graphics, Inc., Waukesha, WI (US)

(72) Inventor: Donald Krause, Lomira, WI (US)

(21) Appl. No.: 14/703,142

(22) Filed: May 4, 2015

Related U.S. Application Data
(60) Provisional application No. 61/987,830, filed on May 2, 2014.

(51) Int. Cl. B29D 11/00; B29C 51/16

(52) U.S. Cl. CPC B29D 11/0073; B29C 51/16; B29C 51/162; B29K 2105/256

(57) ABSTRACT

A lenticular images is attached to a thermoformed container during the thermoforming process by pre-forming the lenticular label and low temperature adhesive material that may fuse to the thermoformed plastic.

### CROSS REFERENCE TO RELATED APPLICATION

This application claims the benefit of U.S. provisional application 61/987,830 filed May 2, 2014 and hereby incorporated by reference.

### BACKGROUND OF THE INVENTION

The present invention relates to a thermoforming and in particular for a thermoforming system providing in-mold application of lenticular labels.

Lenticular images provide for animated or 3-D effects by placing a lenticular lens over multiple (2 or more) interlaced images. The lenticular lens selectively displays one of the interleaved images depending on the angle of the viewer. An animated effect is produced by selecting images that represent different “frames” of an animation so that the animation is viewable as one changes the angle of viewing. 3-D image is produced by selecting images that reproduce the binocular disparity of images viewed at slightly different angles by each eye. The lenticular lens then presents a different image to each of the viewer's eyes to generate a stereographic effect.

The lenticular lens is normally a transparent plastic sheet that includes a set of ribs on a front of the sheet each providing a set of parallel semi-cylindrical lenses each having a line focus on the interlaced images for an anticipated viewing distance. The term “semi-cylindrical lens” is not intended, and does not require a constant curvature radius but should be considered to include all elongate lens shapes that conform in cross-section to cylinders, ellipses, pyramids, trapezoids, parabolas and the like. In one form the semi-cylindrical lens will closely approximate a hemi-cylindrical, lens

The interlaced image associated with the lenticular lens is typically printed directly on the flat back surface of the lenticular lens. However, it is also possible to first print the interlaced image to a substrate (e.g., paper, plastic, metal, glass or wood) and then join, for example, using an adhesive, the substrate bearing the image to the lenticular lens (i.e., thereby creating the lenticular image).

The plastic material of a lenticular lens is commonly extruded, cast, calendared or embossed. This latter embossing process employs a precisely made lenticular pattern-forming roller (e.g., an engraved cylinder) having a groove pattern on its outer surface that presses into the plastic the shape of the lenticular lenses. When the groove pattern extends parallel to the axis of the cylinder, the roller may be used to emboss material in a continuous longitudinally-extending web so that lenticules run across or transverse to the length of the web. Such a pattern-forming device can be referred to as a “transverse pattern-forming roller”. U.S. Pat. No. 6,624,946 hereby incorporated by reference, describes a transverse pattern-forming roller used to emboss web material.

The lenticular lenses must ordinarily be manufactured with precise tolerances in order to avoid image problems matched to the interleaved images, for example, “bleed through” where a multiple (more than one) of the interleaved images are visible at one angle at the same time. U.S. Pat. No. 6,060,003 describes special techniques to inhibit distortion in the lenticular pattern as the plastic sheet cools. Distortion of the lenses may adversely affect viewing or “flip” of the images as the image angle changes.

While lenticular images are used in a variety of applications, use of lenticular images for labeling consumer packaging using curved containers, such as cans and bottles, has been largely limited by difficulties attendant to attaching the lenticular images to a curved or irregular surface, that may be resistant to common adhesive attachment.

### SUMMARY OF THE INVENTION

The present invention provides a method of applying lenticular labels to thermoformed packages. The relatively rigid lenticular material is printed flat and then pre-formed to an approximate shape of the ultimate packaging. A low-temperature adhesive material laminated to the back of the lenticular material allows bonding of the lenticular material to a thermoformed plastic during this low temperature thermoforming process to provide an integrated label and package.

Specifically, the invention, in one embodiment, provides a method of forming a package by attaching to an inner surface of a lenticular label a thermally activated adhesive material, the lenticular label having a transparent lens array outer surface positioned over a printed image having multiple interleaved portions matching a periodicity of the lens array. The lenticular label is pre-formed into a nonplanar configuration corresponding to a thermoforming mold and, after pre-forming, inserted into the thermoforming mold so that the outer surface is adjacent to a wall of the thermoforming mold. Finally, a thermally softened plastic sheet is drawn into the thermoforming mold and against the walls of the thermoforming mold to adhere to the thermally actuated adhesive material on the inner surface of the lenticular label.

It is thus a feature of at least one embodiment of the invention to provide a method of integrally attaching a lenticular label to a plastic container without damage to the lens array. The use of low temperature thermoforming process allows a thermal fusion of the low temperature adhesive without substantial risk of damage to the lens array. Pre-forming the relatively rigid lenticular label allows attaching the lenticular label to the relatively thin material of a thermoformed container without substantially affecting the dimensions of the container.

The drawing may use an air pressure across the thermally softened plastic sheet to draw the thermally softened plastic sheet against the walls of the thermoforming mold.

It is thus a feature of at least one embodiment of the invention to provide a label material compatible with in-mold labeling of thermoformed containers. The lens surface provides a ready path of air between the lenticular label and the mold to assist in the vacuum drawing of the thermoformed material.

The fusing may employ heat drawn from the thermally softened plastic sheet and/or be actuated at a temperature of the thermally softened plastic sheet to fuse to the thermally softened plastic sheet.

It is thus a feature of at least one embodiment of the invention to permit a thermal fusing without the need for temperatures incompatible with vacuum forming.

The step of pre-forming may pre-heat the lenticular label to less than 300 degrees Fahrenheit and more than 200 degrees Fahrenheit.

It is thus a feature of at least one embodiment of the invention to prevent the relatively low thermal mass of the thermoformed material to be cooled by the larger thermal mass of the lenticular label thereby making the fusing process possible.

The pre-forming may apply the inner surface of the lenticular label to a pre-forming mold surface to conform thereto.

It is thus a feature of at least one embodiment of the invention to provide a pre-forming of the lenticular label that does not damage the lens surfaces.

The lenses of the transparent lens array may be distorted to image the printed image applied to the rear surface of the transparent lens array after pre-forming of the lenticular label.

It is thus a feature of at least one embodiment of the invention to preserve the optical correctness of the lenticular array during the pre-forming process.

The lenticular label may be pre-formed into a portion of the cylinder and lenses of the lens array may be semi-cylindrical lenses and the axes of the semi-cylindrical lenses may be substantially parallel with an axis of a cylindrical of the portion of the cylinder.

It is thus a feature of at least one embodiment of the invention provide a curvature to the lenticular label that reduces optical distortion.

These particular objects and advantages may apply to only some embodiments falling within the claims and thus do not define the scope of the invention.

### BRIEF DESCRIPTION OF THE DRAWINGS

FIG. 1a is a perspective view of a lenticular label in partial cutaway showing the lens array and interleaved images;

FIG. 1b is a figure similar to FIG. 1a showing pre-forming of the label prior to attachment to a thermoformed container;

FIG. 1c is a perspective view of a thermoforming mold showing insertion of the pre-formed label into a mold cavity;

FIG. 2a is a cross-sectional view of the label of FIG. 1a;

FIG. 2b is a cross-sectional view of a molding plug used for pre-forming the label of FIG. 1b;

FIG. 2c is a cross-sectional view through one mold cavity of FIG. 1c showing placement of the particular label in the mold cavity as a softened thermoformed sheet is pulled over the cavity openings;

FIG. 3 is a figure similar to FIG. 2c showing a drawing-in of the thermoformed sheet to the walls of the mold cavity and the inner surface of the pre-formed lenticular label;

FIG. 4 is a cross-sectional view through a container after die cutting and showing the lenticular label adhered to the outside of the container;

FIG. 5 is a perspective view of the container FIG. 4; and

FIG. 6 is a cross-section through the lens array of FIG. 1 showing a lens curvature before and after pre-forming.

### DETAILED DESCRIPTION OF THE PREFERRED EMBODIMENT

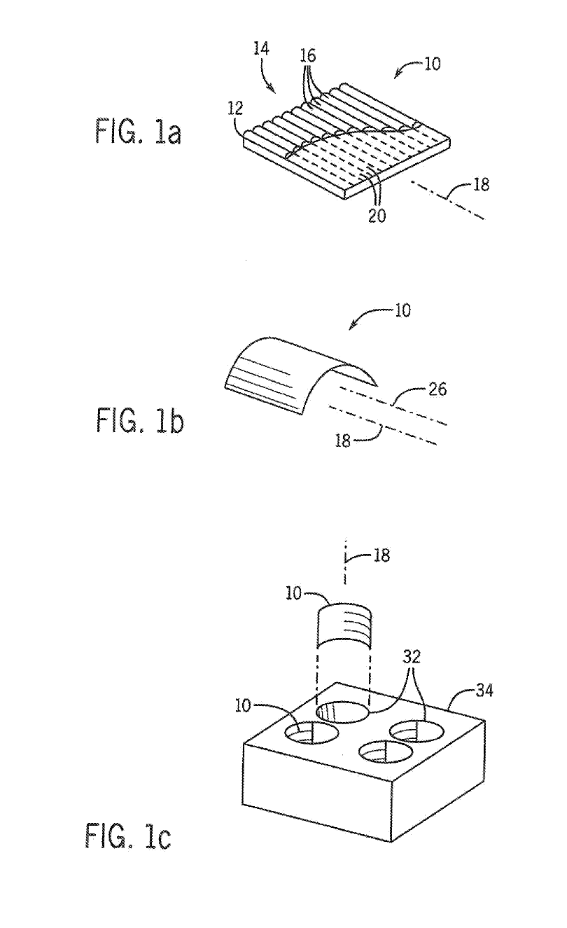

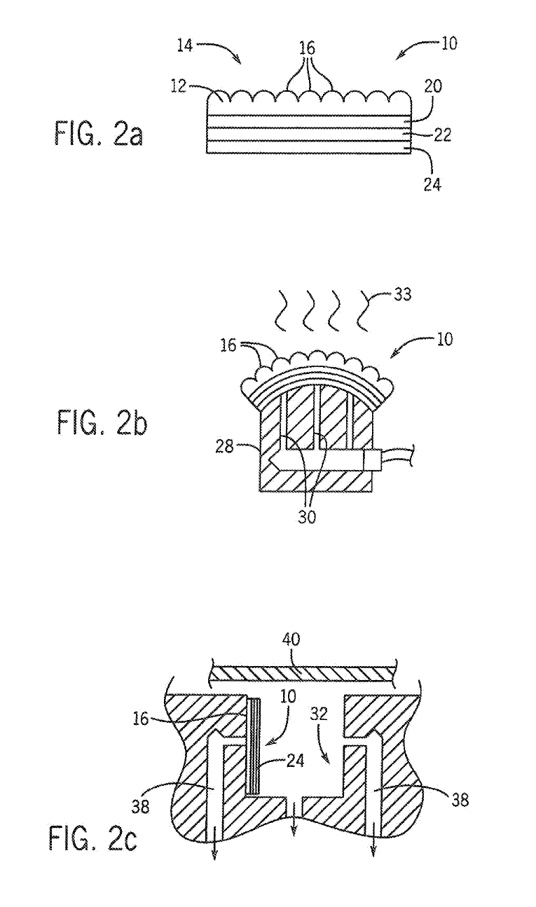

Referring now to FIG. 1a and 2a, a lenticular label 10 may provide for a transparent lens array sheet 12 constructed of a transparent and optically clear thermoplastic such as PVC, APET, PETG or the like. An outer surface 14 of the sheet 12 may be embossed with a lens array providing multiple semi-cylindrical lenses 16 whose semi-cylindrical axes are generally parallel along an axis 18 within the plane of the sheet 12. Each of the lenses 16 has a focal length approximately equal to the thickness of the array sheet 12 and lenses 16 are spatially arranged periodically along an axis perpendicular to the axis 18.

An interlaced image 20 comprised of adjacent image stripes matching a periodicity of the lenses 16 may be printed on the rear surface of the sheet 12 in image layer. This image layer is typically covered within an opaque white ink in a backer layer 22 providing improved reflectivity to the printed interlaced image 20 when viewed through the lenses 16. As is understood in the art, an interlaced image 20 will be comprised of a set of image strips approximately equal in width to a width of the semi-cylindrical lenses 16 where adjacent strips provide portions of different images. Lenticular lenses are well known and commercially available. Methods for using lenticular lens technology are described in detail in U.S. Pat. Nos. 5,113,213; 5,266,995; 5,488,451; 5,617,178; 5,847,808; and 5,896,230 (all of which are incorporated herein by reference).

A low temperature adhesive material 24 is laminated to the inner side of the backer layer 22 or the images 20 and may be a polypropylene with a low melt point between 200 and 300 degrees Fahrenheit being generally compatible with the temperature of thermoforming but much less than the temperature required of injection molding or the temperatures used to form the lenticular label 10. The adhesive material 24 may be adhesive only at the melting point temperatures or may have a room temperature tackiness. The adhesive material 24 may be fused to the sheet 12 or attached with a separate adhesive material. The low temperature adhesive 24 may incorporate a white opaque material thereby eliminating the need for separate backer layer 22.

Referring now to FIG. 1b and FIG. 2b, the label 10 may be pre-formed, for example, into a arcuate shape following a section of a cylinder having a cylinder axis 26 generally parallel or coincident with axis 18. This pre-forming may apply the inner surface of the label 10 to a plug mold 28 contacting that inner surface, for example, and pulling the inner surface down against the plug mold by vacuum lines 30 (allowing ambient air pressure press the label 10 into conformance with an upper surface of the plug mold 28). Heat 33 may be applied, for example, by radiant heaters or ovens to assist in this forming process and to preheat the label 10 to assist in the fusing operation to be described below.

Referring now to FIG. 1c and FIG. 2c, the pre-formed label 10 may then be inserted into a mold cavity 32 of an thermoforming mold 34 so that an outer surface of the label 10 having the exposed lenses 1 is adjacent to an inner wall of the mold cavity 32. In this example, the mold cavities 32 describe the outer surface of product cups and maybe fabricated of a metal material such as aluminum. The mold cavity 32 may provide for multiple vents 38 that can be used to draw vacuum in the mold cavity 32. In this regard, the grooves between the lenses 16 allow the flow of air from the mold cavity 32 into vents 38 otherwise covered by the label 10 even when the label 10 is pulled against the wall of the mold cavity 32. At this time a thermally softened thermoplastic sheet 40 may be positioned above the openings of the mold cavities 32.

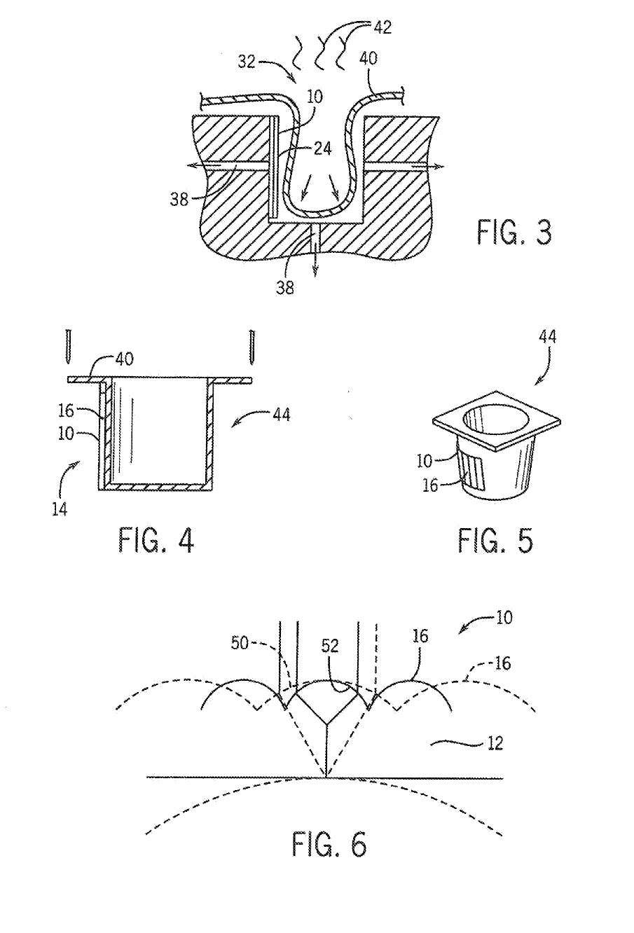

Referring now to FIG. 3, the removal of air from the vents 38 and the outside air pressure draws the thermally softened thermoplastic sheet 40 down into the mold cavity 32 and up against the inner surface of the lenticular label 10 where the outer surface of the softened thermoplastic sheet 40 fuses by inter-melting with the adhesive layer 24 using heat supplied from the softened thermoplastic sheet 40 supplementing the preheating of the label 10. Additional heat 42 may he applied during the steps of FIGS. 2c and 3.

Referring now to FIGS. 4 and 5, the resulting container 44 is then provided by the cooled and rigified sheet 40 die cut around its upper lip and having adhered to its outer surface the label 10 so that the lenses 16 of the label 10 are exposed on an outer surface of the bus pre-formed container.

Referring now to FIG. 5 the shape of the lenses 16 before pre-forming of the lenticular label 10 may be geometrically stretched to provide for distorted profile 50 narrower than a desired profile 52. The distorted profile 50 will be widened by an expected distortion caused by pre-forming of the lenticular label 10 as shown in FIG. 1b. In this way, the widening of the lenses 16 may be set to bring the lens profiles into a desired geometric configuration.

Certain terminology used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What I claim is:

1. A method of forming a package or the like comprising:
(a) attaching to a inner surface of a lenticular label a thermally activated adhesive material, the lenticular label having a transparent lens array outer surface positioned over a printed image having multiple interleaved portions matching a periodicity of the lens array;
(b) pre-forming the lenticular label into a nonplanar configuration corresponding to a thermoforming mold:
(c) inserting the lenticular label after pre-forming into the thermoforming mold so that the outer surface is adjacent to a wall of the thermoforming mold; and
(d) drawing a thermally softened plastic sheet into the thermoforming mold and against walls of the thermoforming mold to adhere to the thermally actuated adhesive material on the inner surface of the lenticular label.

2. The method of claim 1 wherein the drawing uses an air pressure across the thermally softened plastic sheet to draw the thermally softened plastic sheet against the walls of the thermoforming mold.

3. The method of claim 1 wherein the fusing employs heat drawn from the thermally softened plastic sheet.

4. The method of claim 1 wherein the thermally actuated adhesive is actuated at a temperature of the thermally softened plastic sheet to fuse to the thermally softened plastic sheet.

5. The method of claim 1 wherein the thermally actuated adhesive material is actuated at less than 300 degrees Fahrenheit to fuse with the thermally softened plastic sheet.

6. The method of claim 1 wherein the step of pre-forming pre-heats the lenticular label to less than 300 degrees Fahrenheit and more than 200 degrees Fahrenheit.

7. The method of claim 1 wherein the pre-forming applies the inner surface of the lenticular label to a pre-forming mold surface to conform thereto.

8. The method of claim 1 wherein lenses of the transparent lens array are distorted to image the printed image applied to a rear surface of the transparent lens array after pre-forming of the lenticular label.

9. The method of claim 2 wherein the distortion reduces a radius of curvature of front surfaces of the lenticular lenses.

10. The method of claim 1 wherein the lenticular label is pre-formed to curve along a portion of a cylinder and wherein lenses of the lens array are semi-cylindrical lenses and wherein axes of the semi-cylindrical lenses are substantially parallel with an axis of a cylindrical of the portion of the cylinder.
